(19) United States
(12) Patent Application Publication
(10) Pub. No.: US 2025/0166499 A1
(43) Pub. Date: May 22, 2025

(54) VEHICLE TERMINAL AND CALCULATING SERVER FOR CALCULATING SAFE DRIVING SCORE BASED ON EDGE COMPUTING

(71) Applicants: Hyundai Motor Company, Seoul (KR); Kia Corporation, Seoul (KR)

(72) Inventors: Seo Won BEUN, Yongin-Si (KR); Sung Hwan MOON, Bucheon-Si (KR); Jae Sang PARK, Seongnam-Si (KR); Seong Woo HONG, Hwaseong-Si (KR); Yun Seok SEOL, Seoul (KR); Myung Hyun LEE, Seoul (KR); Seong Man KANG, Seoul (KR); Jae Yul WOO, Seoul (KR)

(73) Assignees: Hyundai Motor Company, Seoul (KR); Kia Corporation, Seoul (KR)

(21) Appl. No.: 18/638,398

(22) Filed: Apr. 17, 2024

(30) Foreign Application Priority Data
Nov. 20, 2023 (KR) 10-2023-0160474

(51) Int. Cl. G08G 1/01; G08G 1/052

(52) U.S. Cl. CPC G08G 1/0133; G08G 1/0112; G08G 1/052

(57) ABSTRACT

A vehicle terminal determining a safe driving score based on edge computing, includes at least one processor; and a storage medium operatively connected to the at least one processor and storing a computer-readable instruction, wherein the computer-readable instruction, when the computer-readable instruction is executed by the at least one processor, is configured to, by the at least one processor, collect driving information of a vehicle, determine a safe driving index for each indicator including at least one of sudden acceleration, sudden deceleration, late-night driving, or sudden lane changing, based on the collected driving information of the vehicle, and transmit the determined safe driving index for each indicator at a preset cycle, wherein the safe driving score is determined based on the safe driving index for each indicator.

### CROSS-REFERENCE TO RELATED APPLICATION(S)

The present application claims priority to Korean Patent Application No. 10-2023-0160474 filed on Nov. 20, 2023, the entire contents of which is incorporated herein for all purposes by this reference.

### BACKGROUND OF THE PRESENT DISCLOSURE

### Field of the Present Disclosure

The present disclosure relates to a vehicle terminal and calculation server for determining a safe driving score based on edge computing.

### Description of Related Art

Usage-based insurance (UBI) may be a service that discounts an insurance premium using driving information of a driver. In other words, a safe driving score may be calculated based on indicators such as the number of sudden accelerations, the number of sudden decelerations, the number of sudden starts, the number of late-night drives, or the like, during a given period in time (e.g., 90 days), and then the insurance premium may be discounted based thereon.

To the present end, a vehicle terminal may collect driving information (e.g., a vehicle speed) of a vehicle at a 1 second cycle, and may transmit the same to an external server, and the external server may calculate a safe driving score based on the driving information. However, in the instant case, there may be problems, in that a measurement cycle is too long, making it difficult to calculate an accurate safe driving index, and a lot of load is effectuated on the external server, making it difficult to rapidly process the driving information.

Furthermore, among the abovementioned indicators, sudden acceleration, sudden deceleration, and sudden starting may be all determined based on a vehicle speed. For example, sudden acceleration may be determined when the vehicle speed increases by 10 m/s or more per second, sudden deceleration may be determined when the vehicle speed decreases by 13 m/s or more per second, sudden starting may be determined when the vehicle speed increases by more than 10 m/s per second from a stopped state, and among the above-mentioned indicators, sudden acceleration and sudden starting may be similar indicators, and there may be a problem in which sudden acceleration and sudden starting are counted as overlapping when the sudden starting is performed from a stopped state.

Furthermore, in the late-night driving, cases in which driving is performed for a short distance may be also included in the number of drives, which leads to a claim of a customer.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle terminal and calculation server for determining a safe driving score based on edge computing, in which load on an external server is reduced, driving information is processed rapidly, problems of sudden acceleration and sudden starting being counted as overlapping when the sudden starting is performed from a stopped state are overcome, and a claim of a customer is prevented, may be provided.

According to an aspect of the present disclosure, a vehicle terminal determining a safe driving score, based on edge computing, includes at least one processor; and a storage medium operatively connected to the at least one processor and storing a computer-readable instruction, wherein the computer-readable instruction, when the computer-readable instruction is executed by the at least one processor, is configured to, by the at least one processor, collect driving information of a vehicle, determine a safe driving index for each indicator including at least one of sudden acceleration, sudden deceleration, late-night driving, or sudden lane changing, based on the collected driving information of the vehicle, and transmit the determined safe driving index for each indicator at a preset cycle, wherein the safe driving score is determined based on the safe driving index for each indicator.

According to an exemplary embodiment of the present disclosure, a calculation server, determining a safe driving score based on edge computing, includes at least one processor; and a storage medium operatively connected to the at least one processor and storing a computer-readable instruction, wherein the computer-readable instruction, when the computer-readable instruction is executed by the at least one processor, is configured to, by the at least one processor, receive a safe driving index for each indicator including at least one of sudden acceleration, sudden deceleration, late-night driving, or sudden lane changing at a preset cycle, the safe driving index for each indicator being determined based on driving information of a vehicle; and determine the safe driving score based on the safe driving index for each indicator received at a preset cycle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an entire system including a vehicle terminal and calculation server for determining a safe driving score based on edge computing according to an exemplary embodiment of the present disclosure.

FIG. 2 is a view exemplarily illustrating important behaviors of driving information of a vehicle, when sudden lane changing occurs.

FIG. 3A and FIG. 3B are views exemplarily illustrating a problem of collecting a yaw rate at a 1 second cycle during yaw movement.

FIG. 3C is a view exemplarily illustrating sudden lane changing.

FIG. 4A and FIG. 4B are views exemplarily illustrating the number for each indicator during a predetermined time period in time, the number per unit distance, and a constant of a generalized linear model according to an exemplary embodiment of the present disclosure.

FIG. 5 is a flowchart illustrating a method for determining a safe driving score based on edge computing according to an exemplary embodiment of the present disclosure.

FIG. 6 is a flowchart illustrating a process of determining sudden acceleration among indicators and accordingly determining a safe driving index for sudden acceleration according to an exemplary embodiment of the present disclosure.

FIG. 7 is a flowchart illustrating a process of determining sudden deceleration among indicators and determining accordingly a safe driving index for sudden deceleration according to an exemplary embodiment of the present disclosure.

FIG. 8 is a flowchart illustrating a process of determining sudden lane changing among indicators and determining accordingly a safe driving index for sudden lane changing according to an exemplary embodiment of the present disclosure.

FIG. 9 is a block diagram of a computing device which may fully or partially implement a vehicle terminal and calculation server for determining a safe driving score based on edge computing according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, predetermined embodiments of the present disclosure will be described with reference to the accompanying drawings. The following detailed description is provided to aid in a comprehensive understanding of a method, a device and/or a system described in the present specification. However, the detailed description is for illustrative purposes only, and the present disclosure is not limited thereto.

In describing the exemplary embodiments of the present disclosure, when it is determined that a detailed description of a known technology related to the present disclosure may unnecessarily obscure the gist of the present disclosure, a detailed description thereof will be omitted. Furthermore, terms to be described later are terms defined in consideration of functions in an exemplary embodiment of the present disclosure, which may vary depending on intention or custom of a user or operator. Therefore, the definition of these terms should be made based on the contents throughout the present specification. The terminology used herein is for describing various exemplary embodiments only and is not to be limiting of the embodiments. As used herein, the singular forms are intended to include the plural forms as well, unless the context clearly indicates otherwise. As used herein, the terms “comprise,” “include,” “have,” or the like, when used in the present specification, specify the presence of stated features, integers, steps, operations, elements, components or a combination thereof, but do not preclude the presence or addition of one or more other features, integers, steps, operations, elements, components, and/or groups thereof.

Furthermore, in an exemplary embodiment of the present disclosure, edge computing refers to processing, analyzing, and storing data close to a location in which the data is generated, enabling fast analysis and response in adjacent to real time, and determining a safe driving index for each indicator based on driving information of a vehicle in a vehicle terminal.

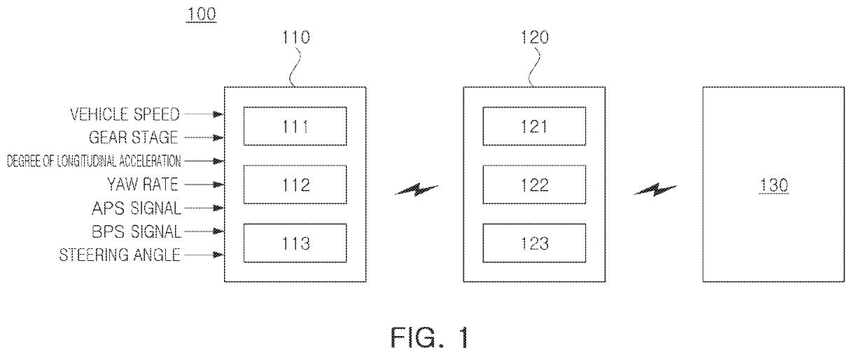

FIG. 1 is a view exemplarily illustrating an entire system 100 including a vehicle terminal 110 and a calculation server 120 for determining a safe driving score based on edge computing according to an exemplary embodiment of the present disclosure. The entire system 100 may include a vehicle terminal 110, a calculation server 120, and an insurance company server 130.

Hereinafter, with reference to FIG. 1, the entire system 100 including the vehicle terminal 110 and the calculation server 120 for determining a safe driving score based on edge computing according to an exemplary embodiment of the present disclosure will be described.

First, the vehicle terminal 110 may collect driving information of a vehicle, and may be configured to determine a safe driving index for each indicator based on the collected driving information of the vehicle. The present vehicle terminal 110 may include a controller 111, a communicator 112, and a storage 113.

First, the controller 111 may collect the driving information of the vehicle, and may be configured to determine the safe driving index for each indicator including at least one of sudden acceleration, sudden deceleration, late-night driving, or sudden lane changing, based on the collected driving information of the vehicle. Vehicle speed, a gear stage, a degree of longitudinal acceleration, a yaw rate, an accelerator position sensor (APS) signal, a brake position sensor (BPS) signal, and a steering angle can be obtained from a vehicle speed sensor, a transmission position sensor, an acceleration sensor, a yaw rate sensor, an accelerator position sensor, a brake position sensor, a steering angle sensor respectively. In the instant case, the driving information of the vehicle may include at least one of a vehicle speed, a gear stage, a degree of longitudinal acceleration, a yaw rate, an accelerator position sensor (APS) signal, a brake position sensor (BPS) signal, or a steering angle. According to this, when determining the safe driving index, sudden starting conventionally used may be replaced with sudden lane changing, to solve a problem in which the sudden acceleration and the sudden starting are counted overlapping when the sudden starting is performed from a stopped state.

Next, the controller 111 may be configured for controlling the communicator 112, which will be described later, to transmit the determined safe driving index for each indicator to the calculation server 120 at a preset cycle.

According to an exemplary embodiment of the present disclosure, the controller 111 may be configured to determine a plurality of safe driving indices for each indicator based on the collected driving information of the vehicle at a cycle, shorter than the preset cycle, and may transmit a safe driving index including a maximum value for each indicator, among the plurality of determined safe driving indices for each indicator, to the calculation server 120. In the instant case, the preset cycle may be 1 second, and the cycle, shorter than the preset cycle, may be 500 ms or less, preferably 200 ms.

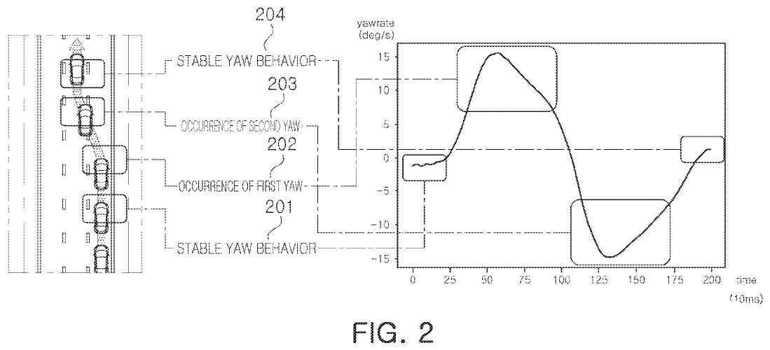

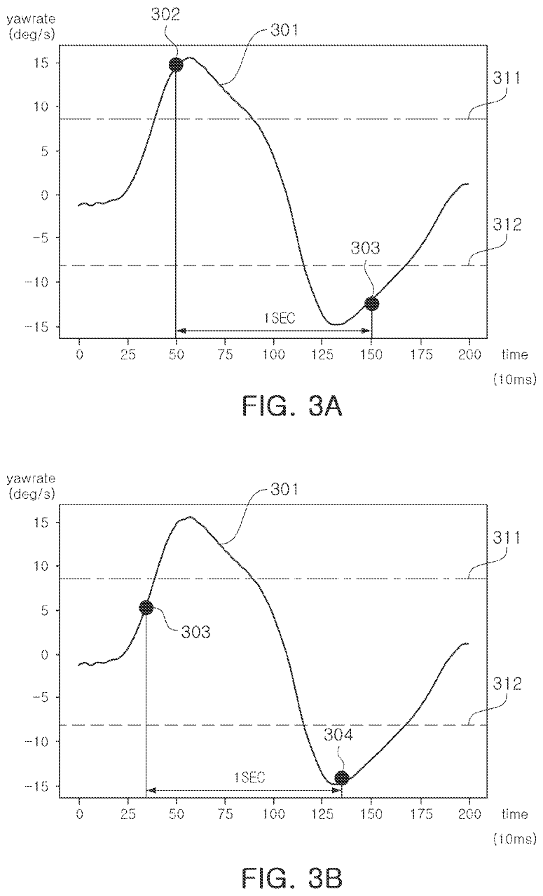

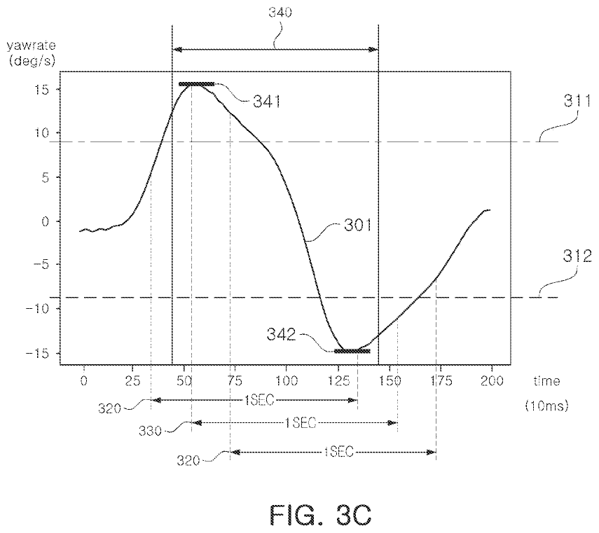

FIG. 2 is a view exemplarily illustrating important behaviors of driving information of a vehicle, when sudden lane changing occurs. FIG. 3A and FIG. 3B are views exemplarily illustrating a problem of collecting a yaw rate at 1 second cycle during yaw movement.

As illustrated in FIG. 2, a yaw behavior of a vehicle changes when sudden lane changing occurs. For example, a yaw behavior of a driving vehicle may be in a stable state (201), and then when sudden lane changing occurs, a first yaw behavior and a second yaw behavior may occur (202 and 203). After the sudden lane changing is completed, the yaw behavior of the vehicle may be changed to have a stable state (204).

In the instant case, when a cycle of collecting a yaw rate is 1 second, yaw rates exceeding threshold values (311 and 312) may not be detected. For example, in FIG. 3A, two points (302 and 303) in which a yaw rate (301) exceeds threshold values (311 and 312) may be accurately detected. In FIG. 3B, because a point (304) exceeding a minimum threshold (312) may be detected, but a remaining point (303) may be within a maximum threshold (311), a point deviating from the maximum threshold (311) may not be detected. According to an exemplary embodiment of the present disclosure, a cycle of collecting the driving information of the vehicle may be less than 1 second (e.g., 200 ms), to detect the driving information of the vehicle for rapidly and accurately determining the safe driving index.

FIG. 3C is a view exemplarily illustrating sudden lane changing. As illustrated in FIG. 3C, when a speed of a vehicle is a minimum speed (e.g., 40 kph), and a maximum value (341) and a minimum value (342), in which an absolute value (301) of a yaw rate within a predetermined cycle (340, e.g., 1 second) deviates from the threshold values (311 and 312), are provided, sudden lane changing may occur. Reference numeral 320 represents a case in which sudden lane changing is not recognized when a yaw rate is collected at a 1-second cycle, and reference numeral 330 represents a case in which sudden lane changing is recognized when a yaw rate is collected at a 1-second cycle.

Additionally, according to an exemplary embodiment of the present disclosure, when the above-mentioned indicators are sudden acceleration and sudden deceleration, a safe driving index may be determined based on a degree of longitudinal acceleration. According to this, different weights or driving characteristics may be reflected for each vehicle type.

Hereinafter, a process of determining a safe driving index for each indicator of sudden acceleration, sudden deceleration, late-night driving, and sudden lane changing will be illustrated. Although predetermined values are limited to facilitate understanding of the present disclosure, it should be noted that predetermined values may be modified as needed depending on a type, a weight, or the like of the vehicle.

First, when the indicator is sudden acceleration, the controller 111 may be configured to determine a safe driving index based on a gear stage, an average vehicle speed, an accelerator pedal amount based on an APS signal, and a degree of longitudinal acceleration.

The controller 111 may determine, based on a degree of longitudinal acceleration at a point in time at which a gear stage is a forward driving stage (D stage), and an average vehicle speed and an accelerator pedal amount satisfy respective predetermined reference values or more, a safe driving index for sudden acceleration according to an amount of change in a degree of subsequent longitudinal acceleration. In the instant case, the forward driving stage (D stage) and the average vehicle speed may be used to confirm whether the vehicle is in a driving state, and the accelerator pedal amount may be used to reflect offset of the longitudinal acceleration and to prevent erroneous detection due to an inclined road.

Additionally, the safe driving index for sudden acceleration may include a level index corresponding to an amount of change in the degree of longitudinal acceleration. The above-mentioned level index may be provided in plural, for example from Lv1 to Lv10. For example, when the amount of change in the degree of longitudinal acceleration is 0.1 g to 0.2 g, the level index may be determined as Lv1, when the amount of change is 0.2 g to 0.3 g, the level index may be determined as Lv2, and other level indices may be determined in a similar manner. Here, the “g” stands for acceleration of gravity.

In the instant case, the predetermined reference value for the average vehicle speed may be a value between 3 kph and 8 kph, and preferably 5 kph. Additionally, the predetermined reference value for the accelerator pedal amount may be a value between 40% and 60%, and preferably 50%.

When the indicator is sudden deceleration, the controller 111 may be configured to determine a safe driving index based on a gear stage, an average vehicle speed, a brake operation based on a BPS signal, and a degree of longitudinal acceleration.

The controller 111 may determine, based on a degree of longitudinal acceleration at a point in time at which a gear stage is a forward driving stage (D stage), an average vehicle speed satisfies a predetermined reference value or more, and a brake is operated, a safe driving index for sudden deceleration according to an amount of change in a degree of subsequent longitudinal acceleration. In the instant case, the safe driving index for sudden deceleration may be set differently depending on at least one of the presence of electronic stability control (ESC) or a steering angle. In the instant case, the forward driving stage (D stage) and average vehicle speed may be used to check whether the vehicle is in a driving state.

Additionally, the safe driving index for sudden deceleration may include a level index corresponding to an amount of change in the degree of longitudinal acceleration. The above-mentioned level index may be provided in plural, for example from Lv1 to Lv10. For example, when vehicle body posture control is not in operation, and the amount of change in the degree of longitudinal acceleration is less than 0.2 g, the level index may be determined as Lv1, when the amount of change is 0.2 g to 0.3 g, the level index may be determined as Lv2, and other level indices may be determined in a similar manner. Furthermore, when the vehicle body posture control is in operation, a steering angle is a certain angle (e.g., 50 degrees) or more, and the amount of change in the degree of longitudinal acceleration is less than 0.3 g, the level index may be determined as Lv1, when the amount of change is 0.3 g to 0.4 g, the level index may be determined as Lv2, and other level indices may be determined in a similar manner.

In the instant case, the predetermined reference value for the average vehicle speed may be a value between 3 kph and 8 kph, and preferably 5 kph.

When the indicator is sudden lane changing, the controller 111 may be configured to determine a safe driving index based on an average vehicle speed, a steering angular speed, and a yaw rate.

The controller 111 may determine, based on a degree of longitudinal acceleration at a point in time at which an average vehicle speed, a steering angular speed, and an absolute value of a yaw rate satisfy respective predetermined reference values or more, a safe driving index for sudden lane changing according to a magnitude of the steering angular speed.

The safe driving index for sudden lane changing may include a level index corresponding to the steering angular speed. The above-mentioned level index may be provided in plural, for example from Lv1 to Lv10. For example, when the steering angular speed is less than 200 deg/sec, the level index may be determined as Lv1, when the steering angular speed is between 200 deg/sec and 300 deg/sec, the level index may be determined as Lv2, and other level indices may be determined in a similar manner.

In the instant case, the predetermined reference value for the average vehicle speed may be a value between 20 kph and 40 kph, and preferably 30 kph. The predetermined reference value for the steering angular speed may be a value between 150 deg/sec and 250 deg/sec, and preferably 200 deg/sec. The predetermined reference value for the absolute value of the yaw rate may be a value between 8 deg/sec and 12 deg/sec, preferably 10 deg/sec.

Lastly, a safe driving index for late-night driving may be the number of late-night driving within a preset period in time (e.g., 11 p.m. To 5 a.m.). In the instant case, a number of late-night driving may be excluded from the number of late-night driving when driving within a preset distance (e.g., less than 5 km).

In the present manner, when driving within a preset distance, a number of late-night driving may be excluded from the number of late-night driving, to reduce a claim of a customer that occur when driving short distances late at late-night.

The communicator 112 may transmit the safe driving index for each indicator described above to the calculation server 120.

The storage 113 may store various programs and data to implement functions performed by the controller 111 described above.

The calculation server 120 may be configured to determine a safe driving score based on the safe driving index for each indicator received from the vehicle terminal 110. The calculation server 120 may include a controller 121, a communicator 122, and a storage 123.

The controller 121 may be configured for controlling the communicator 122 to receive the safe driving index for each indicator at a preset cycle.

Thereafter, the controller 121 may be configured to determine a safe driving score based on the safe driving index for each received indicator.

For each indicator, the controller 121 may accumulate the number of safe driving indices, equal to or greater than a predetermined reference indicator during a predetermined time period (e.g., 90 days), for each of the indicators, may convert the accumulated number of safe driving indices to the number per unit distance, and may be configured to determine then the safe driving score based on the converted number of times per unit distance.

According to an exemplary embodiment of the present disclosure, the controller 121 may be configured to determine the safe driving score by applying the converted number of times per unit distance to a generalized linear model (GLM). Because the generalized linear model described above may be an extended linear model that includes cases in which dependent variables are not normally distributed, and may be a widely known technology, a detailed description thereof will be omitted.

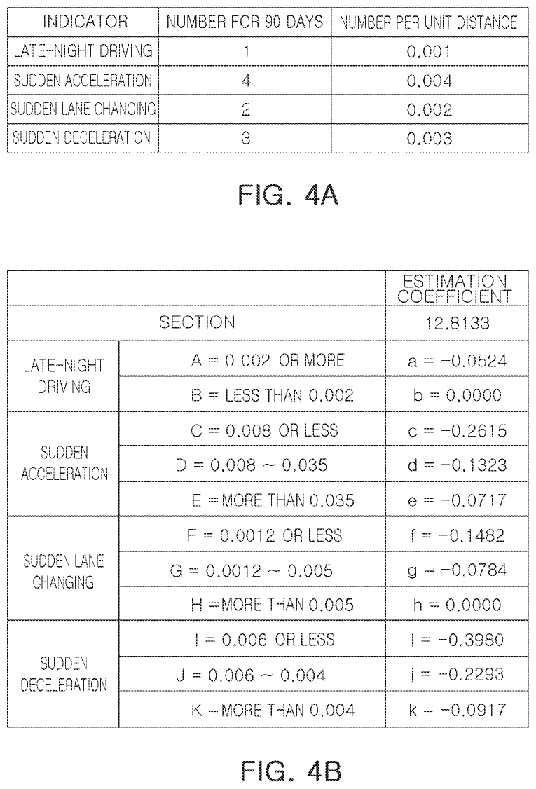

FIG. 4A and FIG. 4B are views exemplarily illustrating the number for each indicator during a predetermined time period in time, the number per unit distance, and a constant of a generalized linear model according to an exemplary embodiment of the present disclosure. FIG. 4A illustrates the number of safe driving indices for each indicator over a predetermined time period in time (e.g., 90 days) and the converted number per unit distance (e.g., 1 km), and FIG. 4B illustrates a constant of a generalized linear model. equation 1 below illustratively illustrates a generalized linear model.

Log(Y)=a×A+b×B+c×C+d×D+e×E+f×F+g×G+h×H+i×I+j×J+k×K [equation 1]

For example, a safe driving score (Y) may be obtained by multiplying the number per unit distance (A to K) converted for each indicator by an estimation coefficient (a to k) corresponding thereto. The above-mentioned estimation coefficient (a to k) may be a constant obtained in advance.

In an exemplary embodiment of the present disclosure, although a generalized linear model is illustrative, but of course, a machine learning model such as a gradient boosting machine (GBM) or the like may also be applied.

Afterwards, the controller 121 may be configured for controlling the communicator 122 to transmit a safe driving score to an insurance company server 130.

The communicator 122 may transmit the safe driving score to the insurance company server 130 under control of the controller 121, and may receive the safe driving index for each indicator from the vehicle terminal 110.

The storage 123 may store various programs and data to implement functions performed by the controller 121 described above.

Finally, the insurance company server 130 may receive the safe driving score, and may be configured to determine an insurance discount rate based on the received safe driving score.

As described above, according to an exemplary embodiment of the present disclosure, a safe driving index for each indicator including at least one of sudden acceleration, sudden deceleration, late-night driving, or sudden lane changing may be determined based on the driving information of the vehicle, but a safe driving index for the sudden acceleration and a safe driving index for the sudden deceleration may be determined, based on a degree of longitudinal acceleration of the vehicle, to reflect different weights and driving characteristics for each vehicle type.

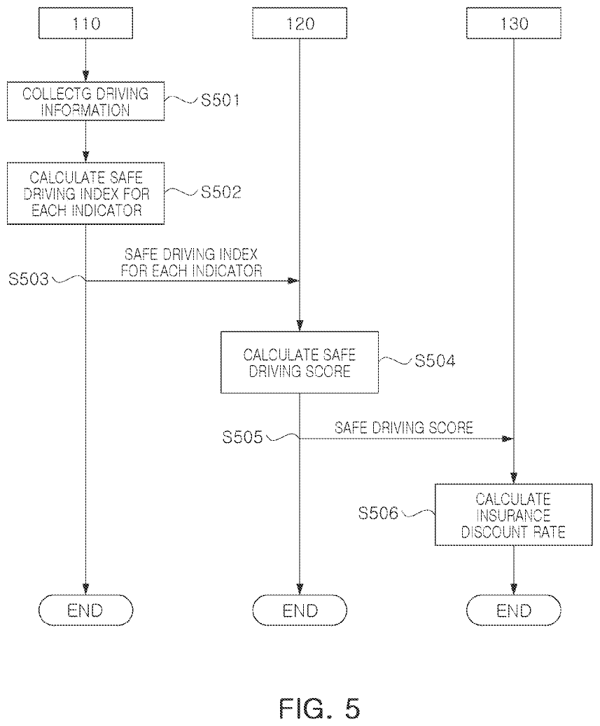

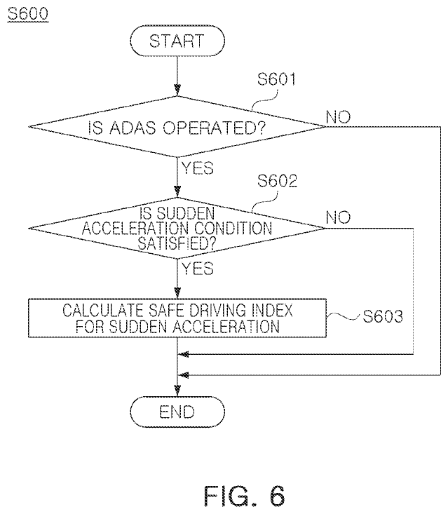

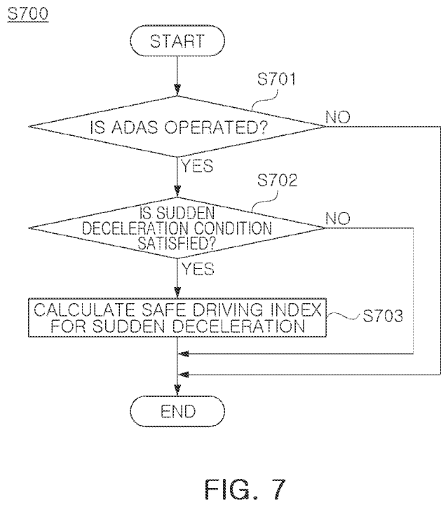

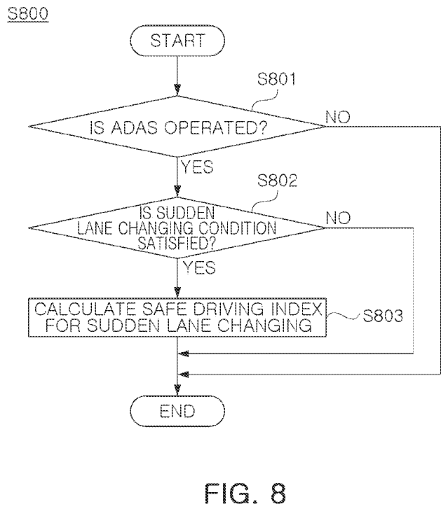

FIG. 5 is a flowchart illustrating a method for determining a safe driving score based on edge computing according to an exemplary embodiment of the present disclosure. FIG. 6 is a flowchart illustrating a process of determining sudden acceleration among indicators and determining accordingly a safe driving index for sudden acceleration according to an exemplary embodiment of the present disclosure. FIG. 7 is a flowchart illustrating a process of determining sudden deceleration among indicators and determining accordingly a safe driving index for sudden deceleration according to an exemplary embodiment of the present disclosure. FIG. 8 is a flowchart illustrating a process of determining sudden lane changing among indicators and determining accordingly a safe driving index for sudden lane changing according to an exemplary embodiment of the present disclosure.

Hereinafter, a method (S500) for determining a safe driving score based on edge computing according to an exemplary embodiment of the present disclosure will be described with reference to FIG. 1, FIG. 2, FIG. 3, FIG. 4, FIG. 5, FIG. 6, FIG. 7, and FIG. 8. However, for simplification, descriptions overlapping FIG. 1, FIG. 2, FIG. 3, and FIG. 4 will be omitted.

Referring to FIG. 1, FIG. 2, FIG. 3, FIG. 4, FIG. 5, FIG. 6, FIG. 7, and FIG. 8, a method (S500) for determining a safe driving score based on edge computing according to an exemplary embodiment of the present disclosure may be started with collecting driving information of a vehicle from a vehicle terminal 110 (S501).

Thereafter, the vehicle terminal 110 may be configured to determine a safe driving index for each indicator including at least one of sudden acceleration, sudden deceleration, late-night driving, or sudden lane changing, based on the collected driving information of the vehicle (S502). In the instant case, as described above, the driving information of the vehicle may include at least one of a vehicle speed, a gear stage, a degree of longitudinal acceleration, a yaw rate, an accelerator position sensor (APS) signal, a brake position sensor (BPS) signal, or a steering angle.

Next, the vehicle terminal 110 may transmit the determined safe driving index for each indicator to a calculation server 120 at a preset cycle (S503).

According to an exemplary embodiment of the present disclosure, the vehicle terminal 110 may be configured to determine a plurality of safe driving indices for each indicator based on the collected driving information of the vehicle at a cycle, shorter than the preset cycle, and may transmit a safe driving index including a maximum value for each indicator, among the plurality of determined safe driving indices for each indicator, to the calculation server 120. In the instant case, as described above, the preset cycle may be 1 second, and the cycle, shorter than the preset cycle, may be 500 ms or less, preferably 200 ms.

Hereinafter, with additional reference to FIGS. 6 to 8, a process of determining the safe driving index for each indicator of sudden acceleration, sudden deceleration, late-night driving, and sudden lane changing will be described.

FIG. 6 is a flowchart illustrating a process (S600) of determining sudden acceleration among indicators and determining accordingly a safe driving index for sudden acceleration according to an exemplary embodiment of the present disclosure.

Referring to FIG. 6, a vehicle terminal 110 may be configured to determine whether an advanced driver assistance system (ADAS) is operating (S601). As a result of the determination, it may be further determined whether a sudden acceleration condition is satisfied when the advanced driver assistance system is operating (S602).

For example, the vehicle terminal 110 may be configured to determine whether the sudden acceleration condition is satisfied when a gear stage is a forward driving stage (D stage), and an average vehicle speed and an accelerator pedal amount satisfy respective predetermined reference values or more. In the instant case, as described above, the predetermined reference value for the average vehicle speed may be a value between 3 kph and 8 kph, preferably 5 kph, and the predetermined reference value for the accelerator pedal amount may be a value between 40% and 60%, preferably 50%.

Thereafter, the vehicle terminal 110 may determine, based on a degree of longitudinal acceleration at a point in time at which a gear stage is a forward driving stage (D stage), and an average vehicle speed and an accelerator pedal amount satisfy respective predetermined reference values or more, a safe driving index for sudden acceleration according to an amount of change in a degree of subsequent longitudinal acceleration (S603).

FIG. 7 is a flowchart illustrating a process (S700) of determining sudden deceleration among indicators and determining accordingly a safe driving index for sudden deceleration according to an exemplary embodiment of the present disclosure.

Referring to FIG. 7, a vehicle terminal 110 may be configured to determine whether an advanced driver assistance system (ADAS) is operating (S701). As a result of the determination, it may be further determined whether a sudden deceleration condition is satisfied when the advanced driver assistance system is operating (S702).

For example, the vehicle terminal 110 may be configured to determine whether the sudden deceleration condition is satisfied when a gear stage is a forward driving stage (D stage), an average vehicle speed satisfies a predetermined reference value or more, and a brake is operated. In the instant case, as described above, the predetermined reference value for the average vehicle speed may be a value between 3 kph and 8 kph, and preferably 5 kph.

Thereafter, the vehicle terminal 110 may determine, based on a degree of longitudinal acceleration at a point in time at which a gear stage is a forward driving stage (D stage), an average vehicle speed satisfies a predetermined reference value or more, and a brake is activated, a safe driving index for sudden deceleration according to an amount of change in a degree of subsequent longitudinal acceleration (S703). In the instant case, as described above, the safe driving index for sudden deceleration may be set differently depending on at least one of the presence of electronic stability control (ESC) or a steering angle.

FIG. 8 is a flowchart illustrating a process (S800) of determining sudden lane changing among indicators and determining accordingly a safe driving index for sudden lane changing according to an exemplary embodiment of the present disclosure.

Referring to FIG. 8, a vehicle terminal 110 may be configured to determine whether an advanced driver assistance system (ADAS) is operating (S801). As a result of the determination, it may be further determined whether a sudden lane changing condition is satisfied when the advanced driver assistance system is operating (S802).

The vehicle terminal 110 may be configured to determine whether the sudden lane changing condition is satisfied when an average vehicle speed, a steering angular speed, and an absolute value of a yaw rate satisfy respective predetermined reference values or more. In the instant case, the predetermined reference value for the average vehicle speed may be a value between 20 kph and 40 kph, and preferably 30 kph. The predetermined reference value for the steering angular speed may be a value between 150 deg/sec and 250 deg/sec, and preferably 200 deg/sec. As described above, the predetermined reference value for the absolute value of the yaw rate may be a value between 8 deg/sec and 12 deg/sec, and may be preferably 10 deg/sec.

Thereafter, the vehicle terminal 110 may determine, based on a degree of longitudinal acceleration at a point in time at which an average vehicle speed, a steering angular speed, and an absolute value of a yaw rate satisfy respective predetermined reference values or more, a safe driving index for sudden lane changing according to a magnitude of the steering angular speed (S803).

Thereafter, the vehicle terminal 110 may transmit the determined safe driving index for each indicator to a calculation server 120 at a preset cycle.

Thereafter, the calculation server 120 may be configured to determine a safe driving score based on the safe driving index for each received indicator at a preset cycle (S504).

For each indicator, the calculation server 120 may accumulate the number of safe driving indices, equal to or greater than a predetermined reference indicator during a predetermined time period, for each of the indicators, may convert the accumulated number of safe driving indices to the number per unit distance, and may be configured to determine then the safe driving score based on the converted number of times per unit distance. In the instant case, as described above, the calculation server 120 may be configured to determine the safe driving score by applying the converted number of times per unit distance to a generalized linear model (GLM).

Afterwards, the calculation server 120 may transmit the determined safe driving score to an insurance company server 130 (S505).

Finally, the insurance company server 130 may receive the safe driving score, and may be configured to determine an insurance discount rate based on the received safe driving score (S506).

As described above, according to an exemplary embodiment of the present disclosure, a safe driving index for each indicator including at least one of sudden acceleration, sudden deceleration, late-night driving, or sudden lane changing may be determined based on the driving information of the vehicle, but a safe driving index for the sudden acceleration and a safe driving index for the sudden deceleration may be determined, based on a degree of longitudinal acceleration of the vehicle, to reflect different weights and driving characteristics for each vehicle type.

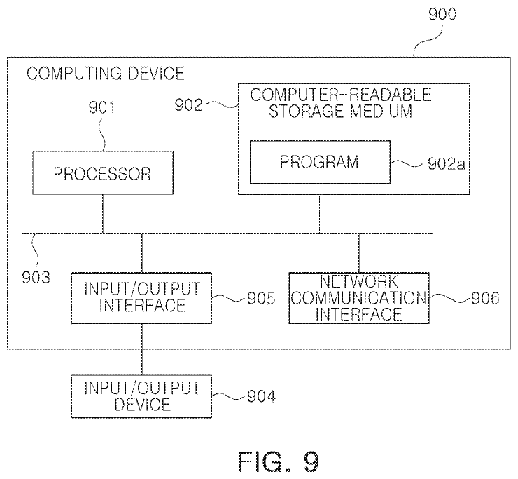

FIG. 9 is a block diagram of a computing device 900 which may fully or partially implement a vehicle terminal 110 and calculation server 120 for determining a safe driving score based on edge computing according to an exemplary embodiment of the present disclosure.

As illustrated in FIG. 9, a computing device 900 may include at least one processor 901, computer-readable storage medium 902, and communication bus 903.

The processor 901 may enable the computing device 900 to operate according to the above-mentioned embodiments. For example, the processor 901 may execute one or more programs stored in the computer-readable storage medium 902. The one or more programs may include one or more computer-executable instructions, which, when executed by the processor 901, cause the computing device 900 to perform operations according to various exemplary embodiments of the present disclosure.

The computer-readable storage medium 902 may be configured to store a computer-executable instruction or program code, program data, and/or information including other suitable form. A program 902a stored in the computer-readable storage medium 902 may include a set of instructions executable by the processor 901. In an exemplary embodiment of the present disclosure, the computer-readable storage medium 902 may include a memory (a volatile memory, such as a random access memory, a non-volatile memory, or an appropriate combination thereof), at least one magnetic disk storage device, at least one optical disk storage device, at least one flash memory device, a storage medium accessible by the computing device 900 and storing target information, or a suitable combination thereof.

The communication bus 903 may interconnect various other components of the computing device 900, including the processor 901 and the computer-readable storage medium 902.

The computing device 900 may also include at least one input/output interface 905 and at least one network communication interface 906, providing an interface for at least one input/output device 904. The input/output interface 905 and the network communication interface 906 may be connected to the communication bus 903. The network may be one of a cellular network, such as global system for mobile communications (GSM), enhanced data rates for GSM evolution (EDGE), general packet radio service (GPRS), Code Division Multiple Access (CDMA), time division-CDMA (TD-CDMA), Universal Mobile Telecommunications System (UMTS), Long Term Evolution (LTE), or another cellular network.

The input/output device 904 may be coupled to other components of the computing device 900 through the input/output interface 905. An example input/output device 904 may include, but is not limited to, an input device such as a pointing device (such as a mouse, a trackpad, or the like), a keyboard, a touch input device (such as a touchpad, a touch screen, or the like), a voice or sound input device, various types of sensor devices, and/or various types of imaging devices, and/or an output device such as a display device, a printer, a speaker, and/or a network card. The example input/output device 904 may be included in the computing device 900 as a component forming the computing device 900, or may be connected to the computing device 900 as a separate device distinct from the computing device 900.

An exemplary embodiment of the present disclosure may include a program for performing methods described in the present specification on a computer, and a non-transitory computer-readable recording medium including the program. The non-transitory computer-readable recording medium may include a program instruction, a local data file, a local data structure, or the like, singly or in combination. The medium may be those designed and constructed for the present disclosure, or may be those commonly available in a computer software field. Examples of computer-readable recording medium may include a magnetic medium such as a hard disk, a floppy disk, or a magnetic tape, an optical recording medium such as a CD-ROM or a DVD, and a hardware device configured to store and perform a program instruction such as a ROM, a RAM, a flash memory, or the like. Examples of the program may include not only a machine language code such as that generated by a compiler, but also a high-level language code which may be executed by a computer using an interpreter or the like.

According to an exemplary embodiment of the present disclosure, a vehicle terminal, instead of an existing server, may be configured to determine a safe driving index for each indicator including at least one of sudden acceleration, sudden deceleration, late-night driving, or sudden lane changing based on driving information of a vehicle, to reduce a load on an external server and rapidly process the driving information.

Furthermore, according to an exemplary embodiment of the present disclosure, among conventional indicators, sudden starting may be replaced with sudden lane changing, to solve a problem in which the sudden acceleration and the sudden starting are counted overlapping when the sudden starting is performed from a stopped state.

Additionally, according to an exemplary embodiment of the present disclosure, in late-night driving, cases in which driving is performed in a short distance may be excluded from the number of driving, preventing a claim of a customer.

Furthermore, according to an exemplary embodiment of the present disclosure, driving data driven by will of a driver and driving data driven by driving assistance/autonomous driving function may be divided and only the driving driven by the will of the driver may be reflected in a safe driving score to respond to a claim of a customer when autonomous driving technology is applied.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle terminal determining a safe driving score based on edge computing, the vehicle terminal comprising:
at least one processor; and
a storage medium operatively connected to the at least one processor and storing a computer-readable instruction,
wherein the computer-readable instruction, in response that the computer-readable instruction is executed by the at least one processor, is configured to, by the at least one processor:
collect driving information of a vehicle,
determine a safe driving index for each indicator including at least one of sudden acceleration, sudden deceleration, late-night driving, or sudden lane changing, based on the collected driving information of the vehicle, and
transmit the determined safe driving index for each indicator at a preset cycle,
wherein the safe driving score is determined based on the safe driving index for each indicator.

2. The vehicle terminal of claim 1, wherein the at least one processor is configured to determine a plurality of safe driving indices for each indicator based on the collected driving information of the vehicle at a cycle, shorter than the preset cycle, and transmit a safe driving index including a maximum value for each indicator, among the plurality of determined safe driving indices for each indicator.

3. The vehicle terminal of claim 1, wherein the driving information of the vehicle includes at least one of a vehicle speed, a gear stage, a degree of longitudinal acceleration, a yaw rate, an accelerator position sensor (APS) signal, a brake position sensor (BPS) signal, or a steering angle.

4. The vehicle terminal of claim 1, wherein the safe driving score is obtained by accumulating a number of safe driving indices, equal to or greater than a predetermined reference indicator during a predetermined time period, for each indicator, converting the accumulated number of safe driving indices to a number per unit distance, and determining based on the converted number of times per unit distance.

5. The vehicle terminal of claim 4, wherein the safe driving score is determined by applying the number per unit distance to a generalized linear model (GLM).

6. The vehicle terminal of claim 1, wherein the at least one processor is configured to operate in response that an advanced driver assistance system (ADAS) is not in operation.

7. The vehicle terminal of claim 1, wherein, in response that the indicator is the sudden acceleration, the at least one processor is configured to determine, based on a degree of longitudinal acceleration at a point in time at which a gear stage is a forward driving stage, and an average vehicle speed and an accelerator pedal amount satisfy respective predetermined reference values or more, a safe driving index for sudden acceleration according to an amount of change in a degree of subsequent longitudinal acceleration, the safe driving index for sudden acceleration including a level index corresponding to an amount of change in the degree of longitudinal acceleration.

8. The vehicle terminal of claim 1, wherein, in response that the indicator is the sudden deceleration, the at least one processor is configured to determine, based on a degree of longitudinal acceleration at a point in time at which a gear stage is a forward driving stage, an average vehicle speed satisfies a predetermined reference value or more, and a brake is operated, a safe driving index for sudden deceleration according to an amount of change in a degree of subsequent longitudinal acceleration, the safe driving index for sudden deceleration including a level index corresponding to an amount of change in the degree of longitudinal acceleration.

9. The vehicle terminal of claim 1, wherein, in response that the indicator is the sudden lane changing, the at least one processor is configured to determine, based on a degree of longitudinal acceleration at a point in time at which an average vehicle speed, a steering angular speed, and an absolute value of a yaw rate satisfy respective predetermined reference values or more, a safe driving index for sudden lane changing according to a magnitude of the steering angular speed, the safe driving index for sudden lane changing including a level index corresponding to the steering angular speed.

10. The vehicle terminal of claim 1, wherein, in response that the indicator is late-night driving, the at least one processor is configured to set a number of late-night driving within a preset period in time as a safe driving index for late-night driving, and excludes the same from the number of late-night driving in driving within a preset distance.

11. A calculation server determining a safe driving score based on edge computing, the calculation server comprising:
at least one processor; and
a storage medium operatively connected to the at least one processor and storing a computer-readable instruction,
wherein the computer-readable instruction, in response that the computer-readable instruction is executed by the at least one processor, is configured to, by the at least one processor:
receive a safe driving index for each indicator including at least one of sudden acceleration, sudden deceleration, late-night driving, or sudden lane changing at a preset cycle, the safe driving index for each indicator being determined based on driving information of a vehicle; and
determine the safe driving score based on the safe driving index for each indicator received at a preset cycle.

12. The calculation server of claim 11, wherein the safe driving index for each indicator to be received is determined in plural based on the collected driving information of the vehicle at a cycle, shorter than the preset cycle, and is a safe driving index including a maximum value for each indicator, among the plurality of determined safe driving indices for each indicator.

13. The calculation server of claim 11, wherein the driving information of the vehicle includes at least one of a vehicle speed, a gear stage, a degree of longitudinal acceleration, a yaw rate, an accelerator position sensor (APS) signal, a brake position sensor (BPS) signal, or a steering angle.

14. The calculation server of claim 11, wherein the at least one processor is configured to accumulate a number of safe driving indices, equal to or greater than a predetermined reference indicator during a predetermined time period, for each indicator, convert the accumulated number of safe driving indices to a number per unit distance, and determine then the safe driving score based on the converted number of times per unit distance.

15. The calculation server of claim 14, wherein the at least one processor is configured to apply the number per unit distance to a generalized linear model (GLM), to determine the safe driving score.

16. The calculation server of claim 11, wherein the at least one processor is configured to operate in response that an advanced driver assistance system (ADAS) is not in operation.

17. The calculation server of claim 11, wherein a safe driving index for sudden acceleration is determined according to an amount of change in a degree of subsequent longitudinal acceleration, based on a degree of longitudinal acceleration at a point in time at which a gear stage is a forward driving stage, and an average vehicle speed and an accelerator pedal amount satisfy respective predetermined reference values or more.

18. The calculation server of claim 11, wherein a safe driving index for sudden deceleration is determined according to an amount of change in a degree of subsequent longitudinal acceleration, based on a degree of longitudinal acceleration at a point in time at which a gear stage is a forward driving stage, an average vehicle speed satisfies a predetermined reference value or more, and a brake is operated.

19. The calculation server of claim 11, wherein a safe driving index for sudden lane changing is determined, based on a degree of longitudinal acceleration at a point in time at which an average vehicle speed, a steering angular speed, and an absolute value of a yaw rate satisfy respective predetermined reference values or more, according to a magnitude of the steering angular speed.

20. The calculation server of claim 11, wherein a safe driving index for late-night driving is set as a number of late-night driving within a preset period in time, and excludes the same from the number of late-night driving in driving within a preset distance.
